(19) United States
(12) Patent Application Publication
(10) Pub. No.: US 2026/0135224 A1
(43) Pub. Date: May 14, 2026

(54) HIGH VOLTAGE BATTERY ROTATION DEVICE

(71) Applicant: International Truck Intellectual Property Company, LLC, Lisle, IL (US)

(72) Inventor: Jonathan Joseph Stec, Milford, MI (US)

(73) Assignee: International Truck Intellectual Property Company, LLC, Lisle, IL (US)

(21) Appl. No.: 18/944,134

(22) Filed: Nov. 12, 2024

(51) Int. Cl. H01M 50/244; H01M 50/262

(52) U.S. Cl. CPC H01M 50/244; H01M 50/262; H01M 2220/20

(57) ABSTRACT

The present disclosure relates generally to the manufacture of high voltage battery packs for use in electric vehicles. Specifically, the present disclosure relates to an improved high voltage battery pack rotation device capable of adjustment for receiving and securing battery packs of varying sizes onto the device. The present high voltage battery pack device enables easy rotation of battery packs for assembly and inspection.

### TECHNICAL FIELD

The present disclosure relates generally to the manufacture of high voltage battery packs for use in electric vehicles. Specifically, the present disclosure relates to an improved rotation device useful in the assembly, manufacturing, and inspection of high voltage battery packs for use in electric vehicles.

### BACKGROUND

Electric vehicles and hybrid electric vehicles require use of a battery pack. During assembly, the battery pack enclosure is required to be hermetically (no air in or out) sealed with fasteners to prevent damage to the battery and potential malfunction. However, due to the weight of the battery pack, attaching fasteners to the underside of the battery pack is typically accomplished without visual guidance. This may result in failure of the seal due to missing fasteners or inadequate placement of the fasteners. Additionally, because these battery packs are heavy, upwards of over 1000 pounds, maneuvering the battery pack during assembly to inspect the seal and ensure proper placement of the fasteners can be difficult.

Therefore, there is a need for an improved high voltage battery pack rotation device for use in the manufacture of a high voltage battery pack, which enables 360-degree rotation and assembly of the battery pack.

A need further exists for an improved high voltage battery pack rotation device that is adjustable in height to maintain the battery pack above the ground in a manner such that the battery pack can be rotated about its longitudinal axis.

A need also exists for an improved high voltage battery pack rotation device that allows a worker to access all areas of the battery pack without having to go under it and permits ease in rotation of the battery pack at various degree increments, i.e. 30-degree increments, for improved placement of fasteners and inspection during manufacturing.

A need further exists for an improved high voltage battery pack rotation device that is adjustable for accommodating battery packs of various sizes.

### SUMMARY

The present disclosure relates generally to the manufacture of high voltage battery packs for use in electric vehicles. Specifically, the present disclosure relates to an improved rotation or rotisserie device useful in the manufacturing of high voltage battery packs for use in electric vehicles. The present rotation device permits a worker to access all sides of a high voltage battery pack for accurate placement of fasteners and ease of assembly.

To this end, in an embodiment of the present disclosure, a battery pack rotation device is provided. The rotation device comprises a support frame having mount assemblies secured to the frame, which are configured for receiving and securing a battery pack in position on the device, and a rotational assembly for rotating the secured battery pack in increments up to 360 degrees.

It is, therefore, an advantage and objective of the present disclosure to provide an improved high voltage battery pack rotation device for use in the manufacture of a high voltage battery pack, wherein the device enables 360-degree rotation of the battery pack.

It is an advantage and objective of the present disclosure to provide an improved high voltage battery pack rotation device that supports the heavy battery pack and enables access all sides of the battery pack during manufacturing for improved placement of fasteners and inspection.

It is a further advantage and objective of the present disclosure to provide an improved high voltage battery pack rotation device which is adjustable to accommodate battery packs of different sizes.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a battery pack rotation device according to the present disclosure.

FIG. 2 illustrates a side view of the battery pack rotation device according to the present disclosure.

FIG. 2A illustrates a grip pad of the battery pack rotation device according to the present disclosure.

FIG. 3 illustrates a top view of the battery pack rotation device according to the present disclosure.

### DETAILED DESCRIPTION

The present disclosure relates generally to the manufacture of high voltage battery packs for use in electric vehicles. Specifically, the present disclosure relates to an improved rotation or rotisserie device useful in the manufacturing of high voltage battery packs for use in electric vehicles. The present rotation device secures the high voltage battery pack onto the device, permitting easy rotation of the heavy battery pack and allowing a worker access to all sides of a high voltage battery pack to ensure accurate placement of fasteners. Additionally, the present battery pack rotation device is easily adjustable to accommodate battery packs of various sizes.

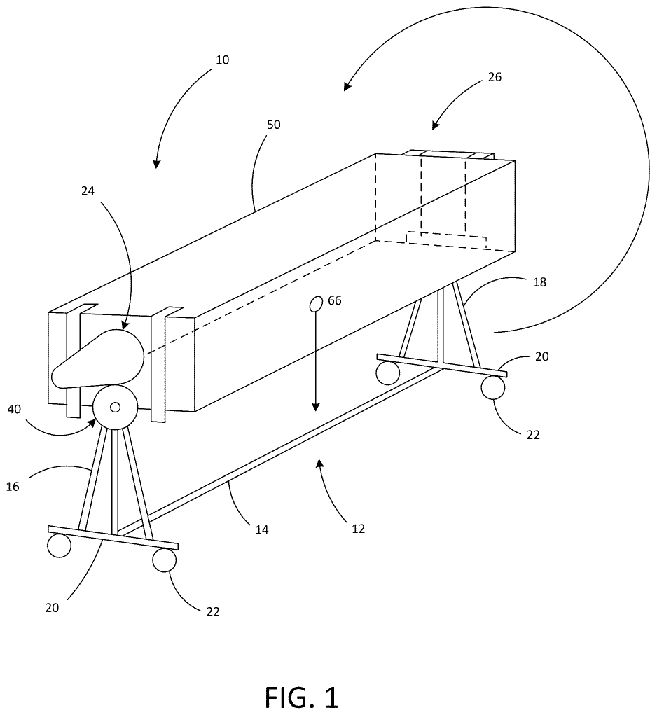

Now referring to the figures, wherein like numerals refer to like parts, FIGS. 1-3 illustrate an example of a battery pack rotation device 10 according to the present disclosure. The battery pack rotation device 10 is designed to be adjustable to accommodate battery packs 50 of varying sizes and secure the battery pack so it can be rotated 360 degrees during assembly and inspection. Rotation of the battery pack 50 during manufacturing permits a worker to visually inspect all sides of the battery pack for accuracy in the placement of fasteners, thereby ensuring a better seal.

As shown in FIGS. 1-3, the battery pack rotation device 10 includes a support frame 12 having a bottom center rail 14, a first vertical side rail 16 positioned on one end of the bottom center rail and a second opposing vertical side rail 18 positioned on an opposing end of the bottom center rail. Each of the first vertical side rail 16 and the second vertical side rail 18 include a horizontal base 20. Each horizontal base 20 supports at least two wheels 22, which enable maneuvering the battery pack rotation device 10 to different locations.

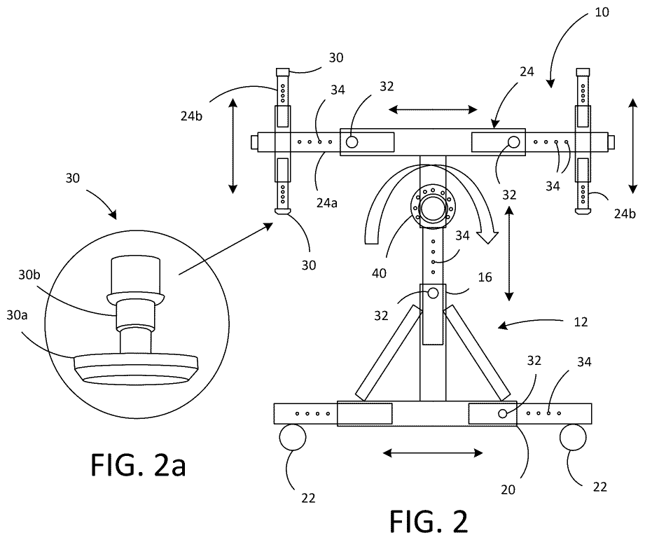

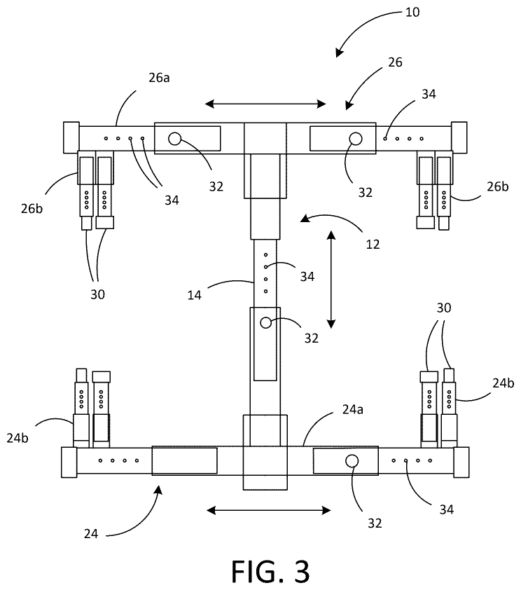

As shown in FIGS. 2 and 3, the battery pack rotation device 10 includes a first mount assembly 24 and a second opposing mount assembly 26. The mount assemblies 24, 26 are configured to receive and secure a battery pack 50 onto the support frame 12 of the battery rotation device 10. The first mount assembly 24 is positioned on top of the first vertical side rail 16, while the second opposing mount assembly 26 is positioned on top of the second vertical side rail 18. The first mount assembly 24 comprises a first horizontal sleeve 24a centrally mounted to the top of the first vertical side rail 16, and a vertical sleeve 24b on each end of the first horizontal sleeve. The second mount assembly 26 comprises a first horizontal sleeve 26a centrally mounted to the top of the first vertical side rail 16, and a vertical sleeve 26b on each end of the first horizontal sleeve.

The vertical sleeves 24b, 26b include a plurality of grip pads 30, which are connected to ends of the vertical sleeves. Each grip pad 30 includes a hard rubber or nylon pad 30a which sits atop a threaded body 30b (FIG. 2A). As shown in FIG. 2, the grip pads 30 are secured on each end of the respective vertical sleeves by the threaded body 30b. The threaded body 30b provides the grip pads 30 with adjustability in length as the pad can be easily rotated toward or away from the end of the vertical sleeve 24b, 26b. In this manner, the grip pads 30 can be adjusted to accommodate and secure any size battery pack 50 onto the battery pack rotation device 10 between the first and second mount assemblies 24,26.

An advantage of the present battery pack rotation device 10 is that various components of the device are adjustable in width, height, and length to accommodate battery packs 50 of varying sizes. For example, the bottom center rail 14 of the support frame 12 can be adjusted laterally to increase the width of the battery pack rotation device. Additionally, each horizontal sleeve 24a, 26a on the respective first and second mount assemblies 24, 26 can also be adjusted laterally to increase the width between the vertical sleeves 24b, 26b on each of the horizontal sleeves. Each vertical sleeve 24b, 26b can be extended in a vertical direction to increase the width between the vertical sleeve. All these adjustability features means that the battery pack rotation device 10 is adaptable for battery packs of various widths and lengths.

Adjustability of the various components of the battery pack rotation device 10 is accomplished by engagement between a locking pin 32 with openings 34 on the specific component. For example, FIG. 3 shows the horizontal sleeve 26a of the mounting assembly 26 having a plurality of openings 34 along the length of the sleeve. As the horizontal sleeve 26a is moved between an inward and an outward lateral position, a locking pin 32 engages with the opening 34 thereby locking the sleeve in the selected position. Engagement between a locking pin 32 and a specific opening 34 on a component provides adjustability in height and/or length of the various components of the present device, for example, the bottom center rail 14 of the support frame 12, the first and second vertical side rails 16, 18 and their respective horizontal bases 20, and the vertical sleeves 24b, 26b. In this manner, the adjustability of the various components in in a horizontal and/or a vertical direction enables the battery pack rotation device 10 to accommodate battery packs of various dimensions.

Additionally, once the locking pins 32 are seated in the corresponding opening 34 in an approximate final location, and the battery pack 50 is mounting into the battery pack rotation device 10, the threaded grip pads 30 can be rotated to securely fasten the battery pack to the rotation device. Using proper position adjustment of the locking pins 32 in combination with the proper positional rotation of the threaded grip 30 pads, provides an unlimited number of adjustment options to secure any size battery pack.

After the battery pack 50 is secured between the first and second mount assemblies 24, 26 of the battery pack rotation device 10, the battery pack is ready for rotation. Rotation of the battery pack 50 is accomplished by an operator grasping and rotating the horizontal supports 24, 26. Optionally, the battery pack rotation device 10 may incorporate a motor (not shown) to assist in the rotation of the battery pack 50. Rotation of the battery pack 50 can be set at in various degree increments up to 360-degree rotation to enable assembly and inspection of the battery pack. For example, the battery pack rotation device 10 may be rotated in 30-degree increments up to a full 360-degree rotation. A rotation dial 40 can be used to adjust and set the rotational increments of the horizontal supports 24, 26. The rotational increments of the present device are adjustable depending on the specific application requirements, for example, detailed inspections, and battery pack sizes.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention. Moreover, the invention illustratively disclosed herein suitably may be practiced in the absence of any element which is not specifically disclosed herein.

I claim:

1. A battery pack rotation device comprising:
a support frame having a bottom center rail, a first vertical side rail positioned on one end of the bottom center rail and a second opposing vertical side rail positioned on an opposing end of the bottom center rail;
a first mount assembly on top of the first vertical side rail;
a second mount assembly on top of the second vertical side rail; and,
wherein the first mount assembly and second mount assembly are configured for receiving and rotating a battery pack.

2. The battery pack rotational device of claim 1, wherein each of the first vertical side rail and the second vertical side rail include a horizontal base.

3. The battery pack rotational device of claim 2, wherein each horizontal base supports at least two wheels.

4. The battery pack rotation device of claim 1, wherein the first mount assembly comprises a first horizontal sleeve mounted to the top of the first vertical side rail, and a vertical sleeve on each end of the first horizontal sleeve.

5. The battery pack rotation device of claim 4, wherein the first horizontal sleeve and each vertical sleeve are adjustable in height and width to accommodate battery packs of varying sizes.

6. The battery pack rotation device of claim 4, wherein each vertical sleeve includes a grip pad on each end of each vertical sleeve.

7. The battery pack rotation device of claim 6, wherein the grip pad includes a grip pad connected to an adjustable threaded body.

8. The battery pack rotation device of claim 7, wherein the grip pad is configured for securing a battery pack between the vertical sleeves.

9. The battery pack rotation device of claim 1, wherein the second mount assembly comprises a second horizontal sleeve mounted to the top of the second vertical rail, and a vertical sleeve on each end of the second horizontal sleeve.

10. The battery pack rotation device of claim 9, wherein the second horizontal sleeve and each vertical sleeve are adjustable in height and width to accommodate battery packs of varying sizes.

11. The battery pack rotation device of claim 9 wherein each vertical sleeve includes a grip pad on each end of each vertical sleeve.

12. The battery pack rotation device of claim 11, wherein the grip pads are adjustable for securing a battery pack between the vertical sleeves.

13. The battery pack rotation device of claim 1, wherein the first mount assembly and second mount assembly are configured for rotating the battery pack in increments.

14. The battery pack rotation device of claim 13, wherein the first mount assembly and second mount assembly are configured for rotating the battery pack in 30-degree increments.

15. The battery pack rotation device of claim 13, wherein the first mount assembly and second mount assembly are configured for rotating the battery pack in 90-degree increments.

16. The battery pack rotation device of claim 13, wherein the first mount assembly and second mount assembly are configured for rotating the battery pack 360 degrees.
